(19) United States
(12) Patent Application Publication
(10) Pub. No.: US 2024/0013527 A1
(43) Pub. Date: Jan. 11, 2024

(54) ARRAY-BASED SYSTEM AND METHOD FOR OBJECT DETECTION NOISE REMOVAL

(71) Applicant: Xtract One Technologies Inc., Toronto (CA)

(72) Inventors: Elliot Mark HOLTMAN, Vancouver (CA); Keegan LINSINK, Vancouver (CA); Gudni Karl ROSENKJAER, Gibsons (CA)

(21) Appl. No.: 18/346,741

(22) Filed: Jul. 3, 2023

Related U.S. Application Data
(60) Provisional application No. 63/358,139, filed on Jul. 3, 2022.
(60) Provisional application No. 63/388,668, filed on Jul. 13, 2022.
(60) Provisional application No. 63/399,636, filed on Aug. 19, 2022.
(60) Provisional application No. 63/400,060, filed on Aug. 23, 2022.
(60) Provisional application No. 63/390,984, filed on Jul. 21, 2022.

(51) Int. Cl. G06V 10/94; G06V 20/52; G06V 10/80

(52) U.S. Cl. CPC G06V 10/95; G06V 20/52; G06V 10/80

(57) ABSTRACT

An array-based system and method for object detection and noise removal. An array-based method can be used to remove background noise by analyzing the measured response at different measurement locations and analyzing signal correlations. Calibration techniques may be required to compensate for individual sensor variation such as gain and mounting orientation. The system consists of a number of pillars that build a single gateway equipped with multiple sensors to monitor patrons to pass through the pillars.

### CROSS REFERENCE TO RELATED APPLICATIONS

The application claims priority to and the benefits of U.S. Provisional Application Ser. No. 63/358,139, entitled “ARRAY-BASED SYSTEM AND METHOD FOR OBJECT DETECTION NOISE REMOVAL” filed on Jul. 3, 2022, U.S. Provisional Application Ser. No. 63/388,668, entitled “SYSTEM AND METHOD FOR CONSTRAINING OBJECT DETECTION FOR MULTI-SENSOR GATEWAYS” filed on Jul. 13, 2022, U.S. Provisional Application Ser. No. 63/399,636, entitled “SYSTEM AND METHOD OF ADAPTIVE WAVEFORM OPTIMIZATION FOR OBJECT DETECTION” filed on Aug. 19, 2022, U.S. Provisional Application Ser. No. 63/400,060, entitled “SYSTEM AND METHOD OF ADAPTIVE TRANSMITTERS FOR OPTIMAL OBJECT DETECTION” filed on Aug. 23, 2022, and U.S. Provisional Application Ser. No. 63/390,984, entitled “MULTI-GATEWAY AND DISTRIBUTED MULTI-PHYSICS ARRAY-BASED SYSTEM” filed on Jul. 21, 2022, the disclosures of which are incorporated herein by reference in their entirety.

### BACKGROUND

The embodiments described herein relate to security and surveillance, in particular, technologies related to removing noise from object detection data.

Background noise poses a significant challenge when interpreting magnetic and electromagnetic data for the classification of threat objects. This background noise can come in a variety of sources including far field noise, for example, powerlines and electric trains, or more localized sources such as building and infrastructure.

Additional noise sources could be mechanical in nature such as building and system vibrations from either people walking near the system or building movement particularly on high-rise buildings where the building can have significant deflections on higher floors. Additional noise sources include nearby equipment such as X-Ray machines, turnstiles, electric doors, elevators, escalators, etc. Because the frequency content and structure of the noise and object responses likely overlap, it is difficult if not impossible to be removed entirely by just analyzing individual sensor data and frequency filtering.

There is a desire to implement a system and method for removing noise from object detection data.

### SUMMARY

An array-based system and method for object detection and noise removal. An array-based method can be used to remove background noise by analyzing the measured response at different measurement locations and analyzing signal correlations. Calibration techniques may be required to compensate for individual sensor variation such as gain and mounting orientation. The system consists of a number of pillars that build a single gateway equipped with multiple sensors to monitor patrons to pass through the pillars.

A system and method of adaptive waveform optimization for object detection for a multi-sensor gateway. The transmitter waveform of the multi-sensor gateway could be optimized based on the object passing through the gate. A pre-defined sweep of different waveforms could be pre-programmed to cycle through different desired waveforms (e.g., different ramp times, shapes, base frequency, etc.). The cycle of multiple waveforms could be selected in a site-dependent way, based on several factors such as expected environmental conditions (e.g., noise, vibration conditions) or expected typical object characteristics (e.g., knives vs long guns, types of expected clutter objects). In another embodiment, the waveform could adaptively change based on the object response and other input information to optimize the response or object coupling as the object passes through the gate.

A system and method of adaptive transmitters for optimal object detection for a multi-sensor gateway. The transmitter waveform of the multi-sensor gateway could be optimized based on the object passing through the gate. Optimizations include using multiple transmitter loops in the gateway system, varying the primary field geometry, using arrays of transmitters with different firing sequences providing different combinations of polarity and strengths to cover different areas of the gateway, different sizes and geometries of transmitter loops. Furthermore, the gateway system can also integrate additional sensor data such as data from video or optical sensors in real-time to optimize transmitter field geometry and/or provide smart or adaptive responses from the transmitter.

A system and method for a multi-gateway and distributed multi-physics array-based system. The system consists of a receiver and/or transmitter in the walkthrough direction and provides an accurate estimate of the geometry and physical properties of an object. The system further utilizes receiver arrays and multiple transmitters to improve accuracy. Further implementations of the system include extending the array concept to sync up with other gateways installed in a single environment into a distributed array object detection system. Transmitters can be synced together in a distributed array configuration which can assist in illumination, receiver/transmitter geometry and reducing noise characteristics.

### BRIEF DESCRIPTION OF THE DRAWINGS

FIG. 1 is a diagram illustrating an exemplary multi-sensor gateway (MSG) system.

FIG. 2 is a block diagram illustrating a gateway detection system.

FIG. 3 is a hardware and software block diagram illustrating micro-services.

FIG. 4 is diagram illustrating a configuration of a single gateway and a single remote reference.

FIG. 5 is diagram illustrating a configuration of multiple gateways and a single reference.

FIG. 6 is diagram illustrating a configuration of single gateway with multiple references.

FIG. 7 is a diagram of a gateway system with two or more optical sensors.

FIG. 8 is diagram illustrating a further embodiment having multiple sensor configuration.

FIG. 9 is a diagram illustrating an object response vs target conductance.

FIG. 10 is a diagram illustrating an exemplary gateway system with a person with walkthrough positions.

FIG. 11 is a diagram illustrating a gateway system with orthogonal transmitters coils within the pillar and/or external transmitter sources.

FIG. 12 is a diagram illustrating a multi-physics distributed gateway approach.

### DETAILED DESCRIPTION

Embodiments of this disclosure include a system that places the computing at the edge by including an onboard processor. Further, different peripherals are added to present the alert information to the security guard, as well as control the throughput rate and operations. This system benefits the patron experience and provides added value to the customer in terms of managing throughput and enhancing security.

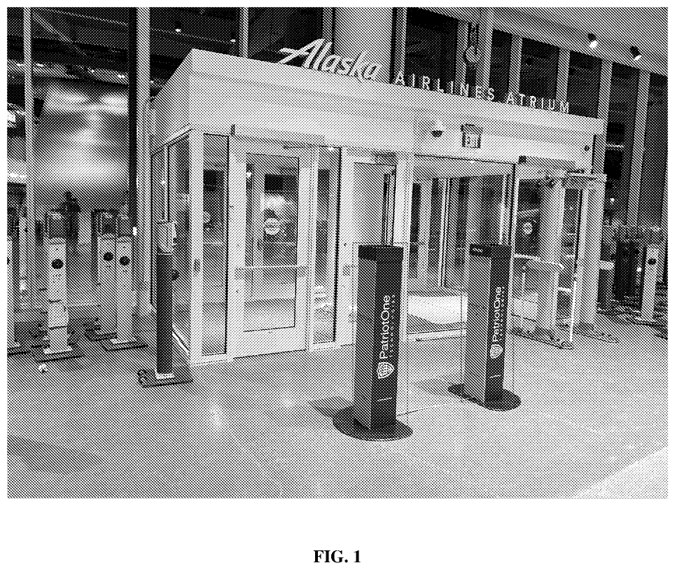

FIG. 1 is a diagram illustrating operation of a multi-sensor gateway (MSG) system. According to FIG. 1, the multi-sensor gateway is placed at the entrance of an airport.

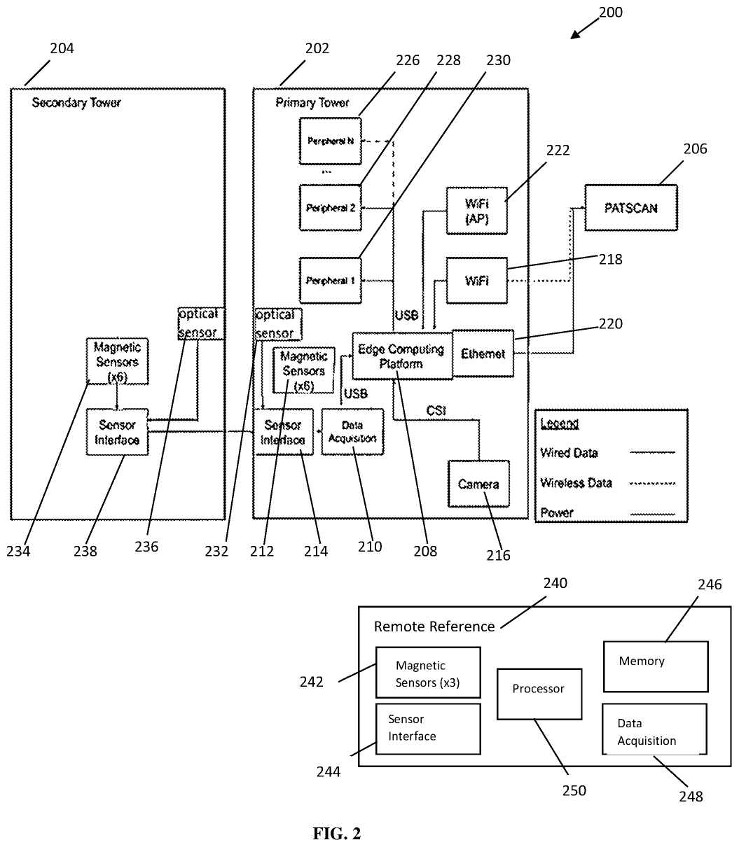

FIG. 2 is a block diagram illustrating a gateway detection system. According to FIG. 2, the gateway detection system 200 consists of a primary tower 202, a secondary tower 204 and a threat detection system such as PATSCAN 206, connected to each other either through a wired or wireless connection. The primary tower 202 consists of the main components of the system including an Edge computing platform 208, data acquisition unit 210, multiple magnetic sensors 212, sensor interfaces 214, one or more cameras 214, a Wi-Fi® module 218 and Ethernet module 220 for connectivity, Wi-Fi® access point 222 and connections to multiple peripherals 226, 228 and 230. The peripherals include optical sensors 232, camera(s), display(s), light(s), speaker(s), accelerometer, Wi-Fi® and Bluetooth units. The secondary tower 204 includes multipole magnetic sensors 234, optical sensor 236 and sensor interface 238 and is connected to the primary tower by a wired data link (e.g., Ethernet). In further embodiments, a wireless connection such as Wi-Fi®, Bluetooth®, IRDA, cellular or other wireless connectivity mediums may be supported.

According to FIG. 2, gateway detection system 200 also consists of a remote reference 240. Remote reference 240 further comprises a 3-axis magnet sensor 242, sensor interface 244, memory 246, data acquisition module 248 and processor 250. Remote reference 240 will communicate wirelessly with primary tower 202 and secondary tower 204.

According to the disclosure, a multi-sensor threat detection system may contain an onboard processor (e.g., Nvidia Jetson) that performs artificial intelligence (AI) to detect the presence of a threat. This removes the need for network dependence on the deployment facility, thereby strongly facilitating the deployment. The onboard processor also reduces the latency of alert, when compared to performing the AI on a server. This results in a smoother screening experience, as the alert latency can handle the high throughput rates. This also removes the reliance on an external server which acted as a single point of failure across all connected systems previously.

The disclosure also contains multiple peripheral components that assist with alerting and control of operations. A camera is used to capture the patron that has alerted and to present evidence to the security guard to help with secondary screening. This assists the security guard in identifying the corresponding threat detection with the patron. Further, the system contains an alert indicator display that indicates an alert and shows the threat location on-body, as well as possibly the image of the alerting patron. There is also an audible signal to indicate an alert.

These peripherals all work to enable the security guard to quickly take decisions on patrons entering the facility with prohibited items in high throughput use cases, such as stadiums or event venues. More information on further embodiments of a multi-sensor gateway is disclosed in U.S. Provisional application Ser. No. 18/093,937, entitled “SYSTEM AND METHOD SMART STAND-ALONE MULTI-SENSOR GATEWAY FOR DETECTION OF PERSON-BORNE THREATS”, filed on Jan. 6, 2023, the disclosure of which is incorporated herein by reference in its entirety.

According to FIG. 2, the system has onboard Wi-Fi®, as well as Ethernet, to connect to a web browser to provide more analytics to the user via a user interface. Furthermore, to enhance the stand-alone capability of the system, wheels are added for better portability. Also, a baseplate is added for better physical stability of the system against vibrations and tipping hazards.

To further help with control of operations, a display is placed on the patron side educating the patrons on how to walk through the system, and what distance to keep from the patron ahead. Furthermore, a backup option is provided for connecting the gateway system over Ethernet to the software platform for control and upgrades of the system algorithms and operations remotely.

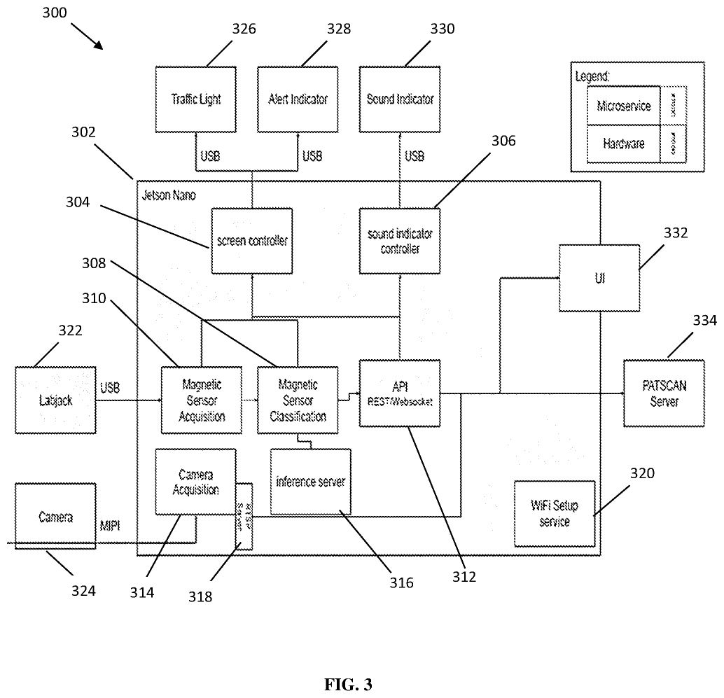

FIG. 3 is a hardware and software block diagram illustrating micro-services. According to FIG. 3, the onboard processor (e.g., Nvidia Jetson) includes such components as screen controller, sound indicator controller, magnetic sensor acquisition module, magnetic sensor classification module, REST/websockets API, camera acquisition module, inference server, RTSP server and a WiFi Setup service. The onboard processor is connected to input and outputs (via USB, Ethernet or wirelessly) including Labjack, cameras, traffic lights, alert indicators, sound indicators. Furthermore, the onboard processor is also connected to a user interface (UI) on a gateway detection system such as a PATSCAN server.

FIG. 3 is a hardware and software block diagram illustrating micro-services. According to FIG. 3, system 300 has an onboard processor 302 (e.g., Nvidia Jetson) including such components as screen controller 304, sound indicator controller 306, magnetic sensor acquisition module 308, magnetic sensor classification module 310, REST/websockets API 312, camera acquisition module 314, inference server 316, RTSP server 318 and a Wi-Fi Setup service 320. The onboard processor is connected to input and outputs (via USB, Ethernet or wirelessly) including Labjack 322, cameras 324, traffic lights 326, alert indicators 328, sound indicators 330. Furthermore, the onboard processor is also connected to a user interface (UI) 332 and a gateway detection system such as a PATSCAN server 334.

According to FIG. 3, the onboard processor (e.g., Nvidia Jetson) utilizes a micro-services architecture. A breakdown of the micro-services architecture is as follows:
Magnetic Sensor Acquisition Service: The classification service takes in data from a LabJack T7 via USB and formats it together for the classifier to use.
Magnetic Sensor Classification Service: The classification service takes in data from acquisition and classifies the data using the inference server. It then sends the results.
Inference Server Service: The Triton Inference Server is used by classification services to perform inference with AI models. Data is sent thru GRPC, and results are returned to the classifier.
Screen Controller Service: Controls the traffic light and alert indicator based on information from acquisition and classifier, as well as user input from the API.
Sound Indicator Controller Service: Controls the speakers based on information from acquisition and classifier, as well as user input from the API.
Camera Acquisition Service: A Deepstream/gstreamer based service that takes in data from a CSI camera and re-transmits it for PATSCAN via RTSP and strips out JPEG frames and saves them to disk.
API Service: A service that provides endpoints for control from the UI.

### Array-Based System for Object Detection Noise Removal

An array-based method can be used to remove background noise by analyzing the measured response at different measurement locations and analyzing signal correlations. For far-field noise sources, correlated signals can be removed since in the far-field each sensor should be influenced similarly from the far-field source. Additional calibration techniques may be required to compensate for individual sensor variation such as gain and mounting orientation (i.e., using static magnetics). Similarly, whole building movement and large-scale environmental effects should affect all sensors similarly and could be removed through similar correlations methods—local vibrations or electromagnetic noise can be removed by comparing local responses to the response from a remote sensor placed in an environment sufficiently far away from the localized noise source.

Multiple embodiments of the array-based system are possible. The simplest and likely least effective version would be using the existing multiple sensors within a single gateway. This is because even though there are multiple sensors within a single two pillar system, the spatial positions of them are similar (only located a few feet apart). A more robust approach would be to use additional sensors placed a significant distance (at least several meters) away from the gateway, ideally in a low noise environment. Since for large buildings many gateways are often installed in close proximity to allow more people to enter the building (for example a stadium with multiple entrances), another possible embodiment is to tether the gateways together and use the other gateways as remote references for each gateway.

Another embodiment is having sufficient data coverage within the measurement array (for example many gateways tethered together) to be able to recover and reconstruct information about the noise source itself (i.e., turn the “noise” into a well characterized source). For example, one could recover parameters such as noise source direction, polarization, amplitude etc. and use this knowledge to compensate or subtract off the response differently for each gateway based on the specific location of the gateway. For many “noise” sources they are likely repeatable for example infrastructure sources which are in fixed positions and characteristics, frequency etc. through a pre-defined cycle. With an array-based system other data interpretation options could exist which could also be more robust with respect to noise such as gradient and tensor measurements which could drop out the noise through the differencing mechanism. In one embodiment, an initial analysis step, prior to regular operation of the gateway, may involve the gathering of noise in the absence of signal, so that the noise may be characterized. In one embodiment, an additional tower may be placed near a known noise source to obtain a strong noise signal. In one embodiment, a site noise survey may be completed before the determination of the number and placement of gateways needed, and an algorithm may provide an optimal number of gateways required along with their placement based on the site survey information. This site survey could be completed using a complete gateway, a subset of the gateway components, or commercially available probes that measure magnetic and or electric fields.

The solution can be combined with other noise removal solutions such as frequency or wavelet filtering, principal component analysis and other denoising methods such as basis pursuit where basis vectors which are known to sparsely fit the data are fit to the noisy signal and the sparsity constraint is used to filter out spurious information. Many combinations or workflows of using remote reference data then standard signal processing techniques or standard signal processing then incorporating remote reference data are possible.

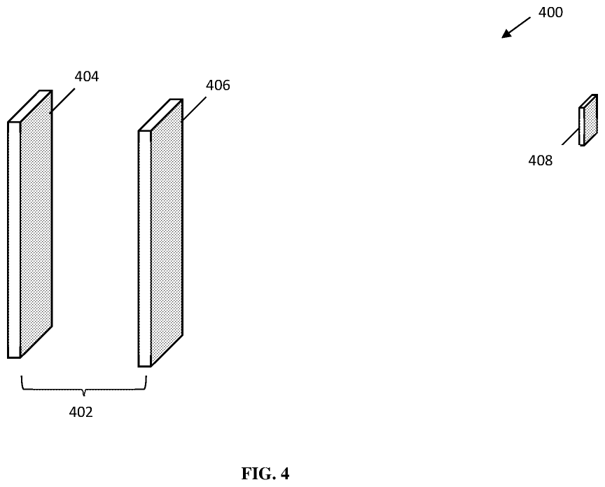

According to the disclosure, a noise robust gateway system with single remote reference station placed some reasonable distance from the gateway is disclosed. The remote reference could have sensors measuring all three components of the field, gradient or tensor measurements, or 1, 2 or 3 single components. Many different permutations are possible and are illustrated in FIGS. 4 to 6.

FIG. 4 is a diagram illustrating a configuration of a single gateway and a single remote reference. According to FIG. 4, Single gateway and single remote reference configuration 400 consists of a single gateway 402 comprising of primary tower 404 (or 1^{st} tower/1^{st} pillar) and secondary tower 406 (or 2^{nd} tower/2^{nd} pillar) and a single remote reference 408.

According to FIG. 4, primary tower 404 and secondary tower 406 can be up to 10 feet apart, whereas remote reference 408 can be located up to 5 kilometers away. As discussed in FIG. 2, remote reference 408 consists of a magnetic sensor, a sensor interface, a data acquisition module, memory (or storage) and a processor. The objective of configuration 400 in FIG. 4 is to assist with removing noise from the object signal.

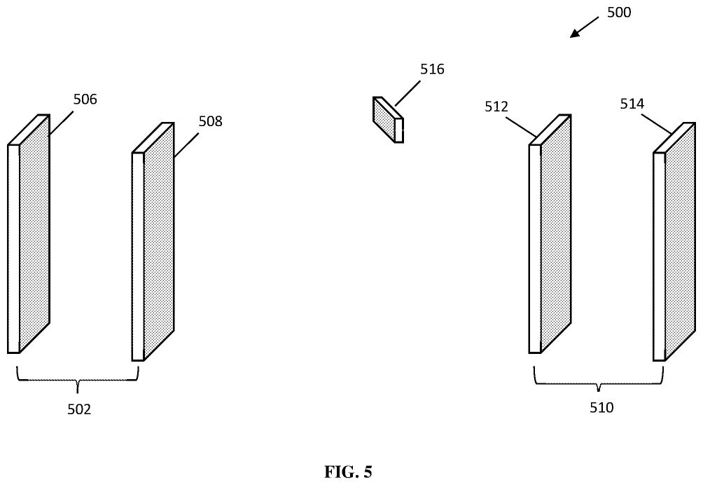

FIG. 5 is a diagram illustrating a configuration of multiple gateways and a single reference. According to FIG. 5, multiple gateway and single reference configuration 500 consists of multiple gateways 502 and 510 and single reference 516. First gateway 502 consists of primary tower 506 and secondary tower 508. Second gateway 510 consists of primary tower 512 and secondary tower 514.

According to FIG. 5, the multiple gateways 502 and 510 can be used as an alternate remote reference. The objective of configuration 500 in FIG. 5 is for all components to work together as a system to assist in removing or filtering noise from the object signal. The more sensors there are (i.e., contained in the towers and remote references), the more the data can be correlated across the towers and assist in the noise processing objective.

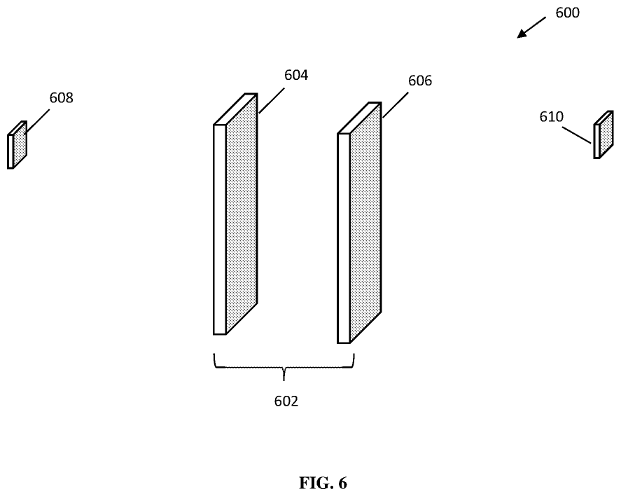

FIG. 6 is diagram illustrating a configuration of single gateway with multiple references. According to FIG. 6, single gateway and multiple reference configuration 600 consists of single gateway 602 and multiple references 608 and 610. Single gateway 602 further consists of primary tower 604 and secondary tower 606.

Configuration 600 of FIG. 6 utilized multiple sets of sensors to split noise from the signal. According to the disclosure, multiple references can do the processing as well (or better) than a single reference sensor.

In one embodiment, the Tower user interface (UI), or a UI enabled by a server or other computing device connected to the tower, may be configured to show one or more of:
estimated or calculated locations of sources of noise,
an indication of the level of noise at least one noise source,
an indication of the level of noise present at each tower,
a map showing optimal placement of towers,
an indication of possible performance degradation in regular operation as a result of extreme noise,
an indication of the operational status (such as gathering data, running, disabled or some other status) of the noise removal system,
an indication of the effectiveness of the noise removal system or method, through a measured statistic such as signal to noise ratio, through a performance metric such as increase in operational effectiveness of the gateway, or through some other indication, or
an option to save or restore analytical or measurement data captured during an initial analysis step

Using a receiver and/or transmitter array in the walkthrough direction, one may be able to recover a better estimate of the geometry and physical properties (such as conductivity) of the object, and may get good data from only a single transmitter pulse, which means it is possible to remove any dependence on not knowing the position of the individual as they walk through the gate, and to reduce latency in the prediction, as the system doesn't have to wait for the entire walkthrough time series to be collected. Also, using a receiver array may remove some influence on walkthrough variability such as speed or direction/swerving since there is now only a reliance on a single or few transmitter pulses, as opposed to an entire time series of measurements over potentially many meters of movement. Empirical data suggests that multiple transmitter pulses provide better accuracy than a single more powerful pulse, likely from the independent information, so similarly one might also expect a receiver array to also improve accuracy.

### Constraining Object Detection for Multi-Sensor Gateways

One of the challenges when interpreting both passive magnetic data and active electromagnetic data from multi-sensor gateways is that the data collected at the gateway sensors is influenced by the walkthrough speed, direction and walking variations, particularly if the data is recorded as amplitude vs time compared to having an absolute position of where the individual is located. This adds an additional degree of freedom when interpreting the data in addition to the object parameter variability. Typical active source metal detectors only use a localized data snapshot through the center of the gate and also have strict traffic flow rules to help constrain their problem. There is a desire to implement a system and method for improving object detection accuracy through external data.

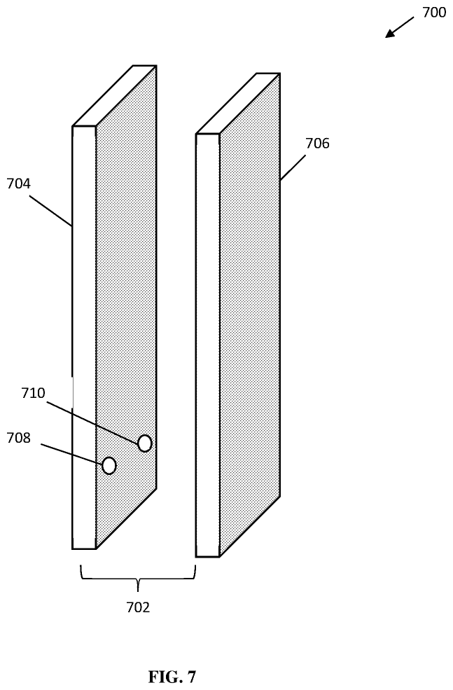

FIG. 7 is a diagram of a gateway system with two or more optical sensors. According to FIG. 7, gateway system 700 consists of gateway 702 having primary tower 704 (or 1^{st} tower/1^{st} pillar) and secondary tower 706 (or 2^{nd} tower/2^{nd} pillar).

According to the disclosure, FIG. 7 further illustrates two or more optical sensors (circles) 708 and 710. The trip times as the individual walks through the sensors can be used to map the time series data into approximate positions. Any combination of optical sensors is possible including within the towers and externally before and or after the gateway. For example, if the velocity is constrained there are fewer degrees of freedom of the data, and hence it may be easier to more accurately recover the information of interest such as the object magnetic and electrical properties compared to less important parameters such as object velocity.

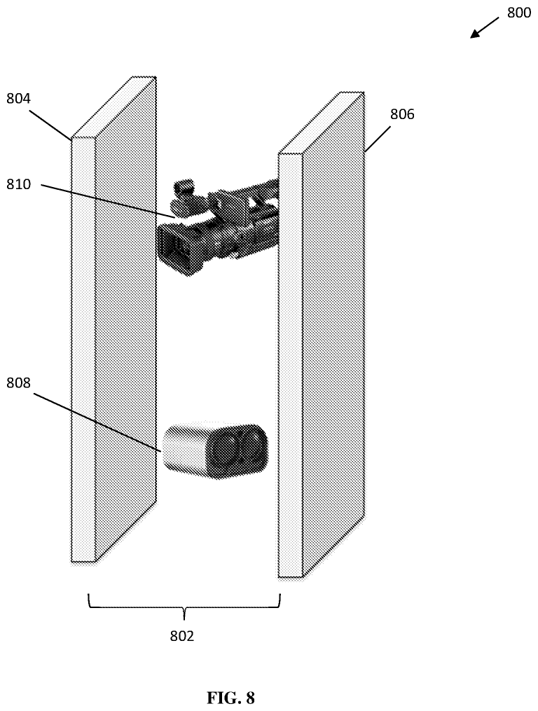

FIG. 8 is diagram illustrating a further embodiment having multiple sensor configuration. According to FIG. 8, multiple sensor configuration 800 consists of gateway 802 having primary tower 804 (or 1^{st} tower/1^{st} pillar) and secondary tower 806 (or 2^{nd} tower/2^{nd} pillar).

According to FIG. 8, many possible sensor configurations are possible to help constrain the problem and fuse the information into the interpretation including LIDAR 808 or video tracking 810 among other possible options. Additional data such as video or LIDAR could also be used to recover 3D segmentations of key objects or properties of interest and track them separately as they move through the gate (e.g., backpacks, bags etc.). The movement of the segmented objects such as bags as they move forward and up and down during walking through the gate could be important in the object classification.

In further embodiments, if a pressure-sensing mat is employed, gait detection based on pressure and weight movement may be used to characterize individuals who have anomalous or noteworthy gaits. This information may be used as identifying information later, if the individual needs to be tracked after moving through the gateway. Gait and mat pressure information can also be used to constrain the object as it moves through the gate.

### Adaptive Waveform Optimization for Objection Detection

According to the disclosure, different objects of interest have different physical properties (for example conductivity of different regions of the object, total conductance, magnetic susceptibility etc.). When either using a frequency domain (sinusoidal input) or time domain waveform (step off etc.), the measured response is dependent on the input waveform (the excitation source). Different objects with different properties will respond differently and potentially more effectively to different input waveforms or frequencies. There is also a further issue of health and safety requirements, which have frequency-dependent field strength limits, which further complicates the issue. There is a desire to implement a means for optimizing the way objects are excited and imaged for object detection.

The current of the transmitter waveform may be optimized, based on the object passing through the gate. This could be done in a variety of different ways. Firstly, a pre-defined sweep of different waveforms could be pre-programmed to cycle through different desired waveforms (different ramp times, shapes, base frequency etc.). The cycle of multiple waveforms could be selected in a site-dependent way, based on several factors such as expected environmental conditions, such as noise and vibration conditions, or expected typical object characteristics, such as the characteristics of knives vs long guns, the expected types of clutter objects, etc.

Another embodiment is more dynamic, wherein the waveform adapts as the individual walks through the gate. Approximate object parameters and properties are estimated based on the response from initial transmitter pulses when the individual is far from the gate, and the waveform and collection procedure are refined as the individual walks towards the gate. This results in more optimal collection parameters when the individual passes through the center of the gate where the highest signal to noise ratio data would be collected. With fixed transmitter installation positions, the orientation of the primary inducing field changes with respect to the individual as they pass through the gateway. There are also advantages to having different waveform properties at different points of the walkthrough for optimal object classification; for example, extraction of lower frequency information as the object is further from the gate and then of finer scale information as the object is closer to the gate/transmitters/receivers. From a hardware perspective, it may also be advantageous to have different waveforms or dipole transmitter moments, because it is easier to shut off the current from low moment systems faster.

This can be extended, in an embodiment, to both on and off-time measurements where the system hunts for three different properties simultaneously in a multi-physics detection problem. This may be embodied in a way where the system might have a variety of different transmitter boards and accompanying transmitter loops each with a specified ‘basis’ waveform, and then the system could adaptively scale the current of each basis to create linear combinations of the waveforms. This could include amplitude and phase shifts, and in the limit could potentially allow for infinite waveform shapes that could be adaptively modified.

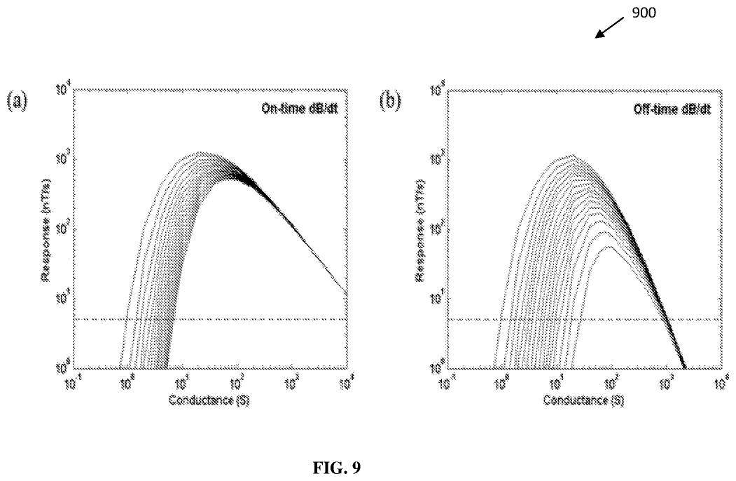

FIG. 9 is a diagram illustrating an object response vs target conductance. According to FIG. 9, sample response 900 from the AEROTEM paper, entitled “Extracting More Information from On-Time Data” by Walker et al. [ASEG Extended Abstracts, 2009:1], is shown illustrating object response vs target conductance. According to FIG. 8, the shape and response measured at the receivers is dependent on the conductance of the target. Furthermore, different types of targets with different conductances will react differently to different excitation sources.

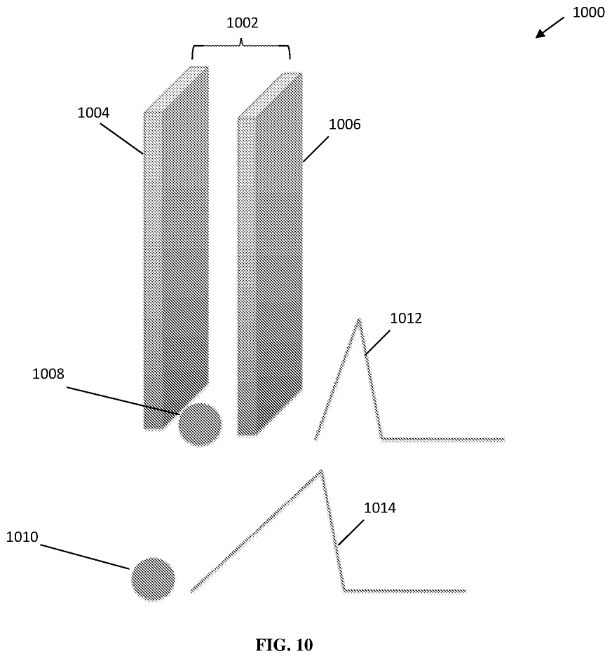

FIG. 10 is a diagram illustrating an exemplary gateway system with a person with walkthrough positions. According to FIG. 10, gateway system 1000 consists of gateway 1002 having primary tower 1004 (or 1^{st} tower/1^{st} pillar) and secondary tower 1006 (or 2^{nd} tower/2^{nd} pillar).

According to FIG. 10, gateway system 1000 further illustrates a person at two example walkthrough positions, person closer to the gateway at 1008 and person further away from the gateway at 1010. The circles (or dots) 1008 and 1010 indicate where the person is with respect to the gateway 1002.

According to FIG. 10, it is possible to have different current waveforms at various positions as the individual walks through the gate (i.e., recovering coarse scale, lower frequency information at large distances, and finer scale, higher frequency information near the center of the gateway). According to FIG. 10, a shorter ramp time 1012 is generated in the center of the gate, and a longer ramp time further from the gate 1014. A graph of hypothetical current waveform vs time is shown for the shorter ramp time 1012 and the longer ramp time 1014.

According to FIG. 10, when person 1008 is closer to gateway 1002 and walking through the gateway 1002, the system turns on and off slower at a lower frequency. However, if person 1010 is further away from gateway 1002, the system turns on and off faster. One benefit of this embodiment is that it enables different objects to collect different data at the gateway.

### Multi-Physics Detection Windows

According to the disclosure, a multi-physics detection procedure could be implemented and include information in the following modes:
On-time
Off-time decay (measuring response as eddy currents dissipate within the object)
Off-time ferrous (fully passive mode, measuring the remnant or induced response from a magnetized object as it passes through the gate)

Based on health and safety guidelines for peak field strengths, it may be advantageous to run certain waveform shapes to optimize the response of the object subject to regulation constraints. The waveform could be optimized to have certain characteristics subject to evolving regulations.

### Adaptive Transmitters for Optimal Object Detection

Different objects of interest have different physical properties (e.g., conductivity of different regions of the object, total conductance, magnetic susceptibility) and different people will walk through the gate in different ways (e.g., left side, middle, right side, fast/slow). Gates should also accommodate people of different sizes (e.g., tall people, short people, fast walker, slow walker, etc.).

Different objects with different properties will respond differently and potentially more effectively to certain primary field illuminations. Furthermore, for non-symmetric objects, there may be an issue with having the primary field null-couple with the object; because of the geometry of certain objects with respect to the transmitter, no current would be induced in the object and therefore the system would measure a minimal or no response, even for objects made of strong conductors. For example, a knife is very thin in one dimension; if the primary field were to nearly or completely null-couple to that object direction, then the system could be “blind” to the object as it passes through the gate. There is a desire to implement a means for optimizing object detection with adaptive transmitters.

According to embodiments of the disclosure, using multiple transmitter loops in a gateway system, the transmitter primary field geometry can be optimized to provide a more robust system with better detection capabilities. This optimization can be done in many ways. For example, it may be desirable for the primary field geometry to change as the object is passing through the gate (in other words have primary field “track” the object/individual as they move).

Varying the primary field geometry may be accomplished by using multiple transmitter loops. For example, even with only two orthogonal transmitter loops the field geometry can easily be modified by changing the relative strength and polarity of the current between the two loops thus rotating the direction of the inducing field. The relative strengths of the current could be optimized to best illuminate the objects and reduce the chance of null coupling.

Many embodiments of the disclosure are possible including arrays of transmitters with different firing sequences giving different combinations of polarity and strengths to cover different areas of the gateway and polarities (for quadrupole arrangement). The transmitter arrays could include transmitters on the side of the gateway, on the floor or below the floor, or an arch type loop transmitter, or any other possible transmitter permutations. The transmitter loops can be of different sizes and geometries to create different inducing field shapes and decays.

Additional sensor data could be combined with this concept. For example, combining video or optical sensor data into the system, one could determine where the object is located in real-time, and optimize the transmitter field geometry to couple maximally with the known individual/object location. If a person passes through the gate to one side, it may also be desirable to change the relative transmitter strength on either side of the gateway to gain maximum information about the object. A further extension would be to design the low-frequency source based on beam forming techniques. This could be related to the specific design of the antenna, or of the receiver so that it has a specific receptive cone. This idea couples with having multiple antennas to adapt from there.

Optimization of the illuminating field may also be constrained based on health and safety guidelines to provide maximum illumination while operating within required codes. The use of this disclosure may be detected by measuring the magnetic field at different points within the gateway as someone walks through it, and checking if the field strength, direction and properties of the field are changing and adapting in response.

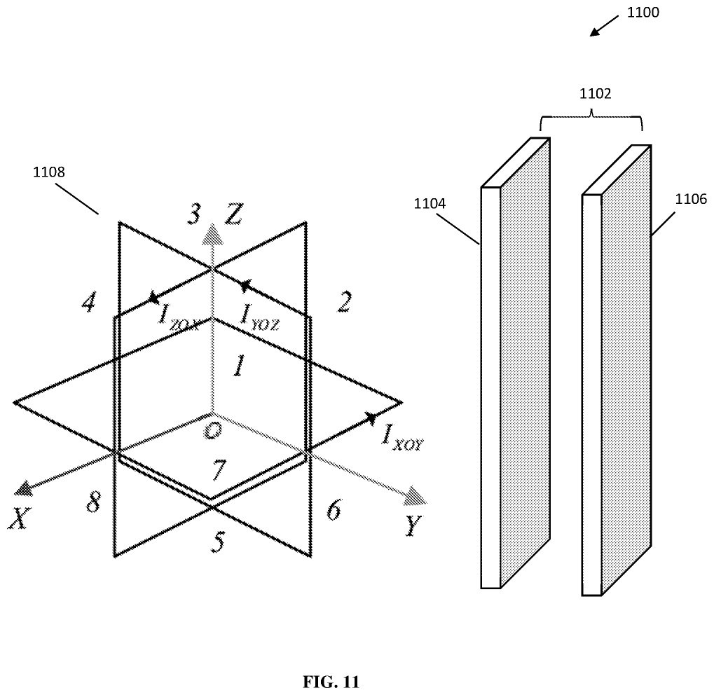

FIG. 11 is a diagram illustrating a further gateway configuration with orthogonal transmitter coils within the pillar and/or external transmitter sources. According to FIG. 11, further orthogonal gateway configuration 1100 comprises gateway system 1002 having primary tower 1104 and secondary tower 1106. According to FIG. 11, graph 1108 illustrates the currents in the Ix, Iy and Iz direction. The currents Ix, Iy and Iz can be modulated as a person walks through the gate for maximum coupling and detection accuracy.

According to FIG. 11, a transmitter loop is placed in the plane of the towers 1104 and 1106 with optimal illumination of the object in different directions. Orthogonal gateway configuration 1100 further comprises 3 orthogonal transmit coils which creates an arbitrary field in different directions. This enables the modulation the direction of the field as a person walks through gateway 1102.

### Multi-Gateway and Distributed Multi-Physics Array-Based System

Given the requirements of having people pass unhindered through the gateway, it can practically be hard to easily illuminate objects with different independent inducing field geometries. The systems also need to be able to operate in environments which could have multiple gateways firing transmitter pulses at the same time or multiple systems in close proximity to each (either the same or different versions of the multi sensor gateway) and potentially even imaging different physical properties (conductivity, remnant magnetization etc.).

One of the challenges when interpreting either passive magnetic data, or active electromagnetic data from multi-sensor gateways is that the data collected at the gateway sensors is influenced by the walkthrough speed, direction and walking variations—the data is an amplitude vs time compared to position. This adds an additional degree of freedom when interpreting the data in addition to the object type. Typical active source metal detectors only use a few transmitter pulses through the center of the gateway and also have strict traffic flow rules to help constrain their problem. Variations in speed could still be an issue as this would stretch and dilate the line profiles and not be repeatable for the interpretation for the same object (for example the difference between the electromagnetic response from a thin conductive plate and two separate conductors is just a dilation of a similar double peak anomaly). If we switched, by way of example, to a simple three receiver array, with one receiver in a central position relative to the transmitter loop, one null coupled on the edge and one forward or behind of the transmitter loop we could gain additional information and be still able to interpret off a single pulse vs having latency issues of needing the full profile walkthrough data. Another practical challenge is the separation between the transmitters and receivers needed to allow a person or persons to pass unhindered through the gateway—it may be desirable to have sources and receivers located as close to the object of interest as possible while still allowing people to pass easily through the gateway. There is a desire to implement a scalable, multi-property array-based object detection system.

According to the disclosure, one can further extend the array concept to sync up with other gateways installed in a single environment into a distributed array object detection system. Transmitters can be synced together and now act as many transmitters and receivers in a large, distributed array configuration as is standard practice in other remote sensing applications. This distributed array approach could help with better illumination and receiving geometry as well as better system noise characteristics. From other remote sensing applications, we know this full distributed array type system gives the best parameter recovery results. It is understood that the exact number of receivers and positions is arbitrary, and the optimal number and positions could be determined by various means such as numerical experimental design and simulations, or practical laboratory studies.

Another embodiment is that the geometry of the problem can be changed by making the individual carry something through the gateway which helps with the detection accuracy. For example, currently the transmitters are approximately a couple of feet away from the objects of interest as are the receivers. One embodiment could potentially improve the detection accuracy by placing a source or receiver closer to the object. From a CONOPS perspective, one possible flow would be to have multi-staged screening process leveraging different physics-based sensors. If the first system was alerted or unsure after passing through the first gateway, instead of having to do a physical search, the individual could be automatically directed to a second lane which could have a different type of gateway imaging different physical properties. An analogy would be at the emergency room if the X-ray was inconclusive, then the doctor might send the patient for a follow-up MRI etc. The individual could also be instructed to pick up an object (likely a small portable transmitter or receiver) which they would carry through the gateway.

The object they picked up would help with the imaging. Furthermore, a medical analogy would be a patient injected with fluorescing imaging dye before an imaging test. The whole approach would be easy to automate and require limited human intervention. The carried object could also help constrain the speed as the person walked through the gate. There are likely many embodiments of adding an object or apparatus directly to the person to help imaging accuracy or having multiple gateways in different configurations integrated with specific efficient operational procedures.

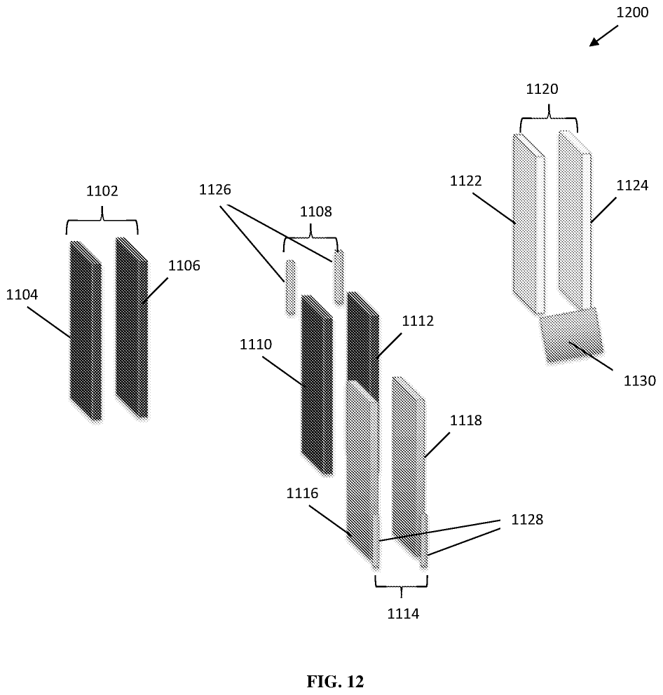

FIG. 12 is a diagram illustrating a multi-physics distributed gateway approach. According to FIG. 12, multi-physics distributed gateway configuration 1200 comprises multiple gateway systems 1102, 1108 (gateway in black), 1120 and 1114 (gateway in gray). Gateway system 1102 further comprises primary tower 1104 and secondary tower 1106. Gateway system 1108 (gateway in black) further comprises primary tower 1110 and secondary tower 1112. Gateway system 1120 further comprises primary tower 1122 and secondary tower 1124. Gateway system 1114 (gateway in gray) further comprises primary tower 1116 and secondary tower 1128.

According to FIG. 12, gateways 1108 and 1114 further comprises standalone transmitters 1126 and 1128 respectively. Gateway 1120 further comprises a loop transmitter 1130 that can be placed on the floor, mat or ceiling.

According to FIG. 12, any arbitrary combination of sensors (transmitters and receivers) can be combined to image different properties. Here the differently colored and shaped gateways represent different sensors imaging different physical properties. The gateways, transmitters and receivers can be combined and placed in any combination (parallel, series, etc.) with modular components such as transmitter etc. bolting on to different systems.

According to FIG. 12, instead of each system functioning independently, multiple gateways (i.e., up to 24 transmitters and receivers) can be combined and work together in close proximity for optimal performance and share data across the system. Furthermore, the system can have shared transmitters and receivers across the gateway system and/or the transmitters and receivers can be placed separately in different places.

According to further embodiments of the disclosure, the first magnetic base station solution is for whole earth imaging and looking at static fields from the earth and nothing related to object detection and gateways. Furthermore, the second magnetic base station is for frequency domain electromagnetic data collected from naturally occurring sources.

According to further embodiments of the disclosure DC currents measurements on the earth is a totally different application than this application. One involves placing source and or receiver down a borehole, this idea involves placing the source and or receiver on the person. Furthermore, embodiments of the disclosure discusses the combination of multiple gateways, sensors and devices into a single system.

According to the disclosure, a multi-sensor gateway system for object detection and noise removal is disclosed. The system comprises a first pillar having a plurality of first sensors, a second pillar having a plurality of second sensors, an integrated camera on the first or second pillar, a Wi-Fi® module on the first pillar configured for the pillars to communicate over Wi-Fi®, a display screen on the first pillar or second pillar for displaying a plurality of screen states, a platform computer server and processor configured to receive data and process the data and a remote reference system.

According to the disclosure, the remote reference system further comprises one or more 3 axis magnetic sensor, a sensor interface, a data acquisition module and memory. The sensors of the first and second pillars of the gateway work together with the remote reference system to perform object detection functionality and noise removal. Furthermore, the system is configured to use an array-based system.

According to disclosure, the noise of the system is background noise. The background noise is selected from a list consisting of field noise, powerlines, cars, electric trains, buildings and infrastructure noise.

According to disclosure, a computer implemented method, using an array-based multi-sensor gateway system, configured to remove background noise for object detection is disclosed. The method comprising the steps of providing a first pillar having a plurality of first sensors, providing a second pillar having a plurality of second sensors, providing an integrated camera on the first or second pillar, providing a Wi-Fi® module on the first pillar configured for the pillars to communicate over Wi-Fi®, providing a display screen on the first pillar or second pillar for displaying a plurality of screen states and providing a platform computer server and processor configured to receive data and process the data, receiving a measured response and analyzing the response for background noise, analyzing the signal for correlations, removing the noise from the measured response, transmitting the measured response to operations and security personnel.

According to the disclosure, the noise of the computer-implemented method is background noise. The background noise is selected from a list consisting of field noise, powerlines, cars, electric trains, buildings and infrastructure noise. According to the disclosure, removing the noise of the method further comprises taking different measurement locations while analyzing the measured response.

According to the disclosure, calibrating the system of the computer-implemented method further comprises compensating for individual sensor variation, gain or mounting orientation.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed. The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

What is claimed is:

1. A multi-sensor gateway system for object detection and noise removal, the system comprising:
a first pillar having a plurality of first sensors;
a second pillar having a plurality of second sensors;
an integrated camera on the first or second pillar;
a Wi-Fi® module on the first pillar configured for the pillars to communicate over Wi-Fi®;
a display screen on the first pillar or second pillar for displaying a plurality of screen states;
a platform computer server and processor configured to receive data and process the data; and
a remote reference system further comprising:
one or more 3 axis magnetic sensor;
a sensor interface;
a data acquisition module; and
memory;
wherein the sensors of the first and second pillars of the gateway work together with the remote reference system to perform object detection functionality and noise removal;
wherein the system is configured to use an array-based system.

2. The system of claim 1 where in the noise is background noise.

3. The system of claim 2 where the background noise is selected from a list consisting of field noise, powerlines, cars, electric trains, buildings and infrastructure noise.

4. A computer implemented method, using an array-based multi-sensor gateway system, configured to remove noise for object detection, the method comprising the steps of:
providing a first pillar having a plurality of first sensors;
providing a second pillar having a plurality of second sensors;
providing an integrated camera on the first or second pillar;
providing a Wi-Fi® module on the first pillar configured for the pillars to communicate over Wi-Fi®;
providing a display screen on the first pillar or second pillar for displaying a plurality of screen states;
providing a platform computer server and processor configured to receive data and process the data;
receiving a measured response and analyzing the response for the noise;
analyzing the signal for correlations;
removing the noise from the measured response; and
transmitting the measured response to operations and security personnel.

5. The method of claim 4 where in the noise is background noise.

6. The method of claim 5 where the background noise is selected from a list consisting of field noise, powerlines, cars, electric trains, buildings and infrastructure noise.

7. The method of claim 4 wherein removing the noise further comprising taking different measurement locations while analyzing the measured response.

8. The method of claim 4 further comprising the step of calibrating the system using calibration techniques.

9. The method of claim 8 wherein calibrating the system further comprises compensating for individual sensor variation, gain or mounting orientation.
